(19) United States
(12) Patent Application Publication
(10) Pub. No.: US 2022/0245436 A1
(43) Pub. Date: Aug. 4, 2022

(54) METHOD AND DEVICE FOR PROCESSING CONVOLUTION OPERATION OF NEURAL NETWORK PROCESSOR

(71) Applicant: FURIOSAAI CO., Seoul (KR)

(72) Inventors: Han Joon Kim, Gyeonggi-do (KR); Young Geun Choi, Gyeonggi-do (KR); Byung Chul Hong, Gyeonggi-do (KR); Min Jae Kim, Seoul (KR); Bon Cheol Gu, Gyeonggi-do (KR)

(73) Assignee: FuriosaAI Co., Seoul (KR)

(21) Appl. No.: 17/620,308

(22) PCT Filed: Jun. 2, 2020
(86) PCT No.: PCT/KR2020/007133

§ 371 Date: Dec. 17, 2021

(30) Foreign Application Priority Data
Jun. 18, 2019 (KR) 10-2019-0072062

(51) Int. Cl. G06N 3/063

(52) U.S. Cl. CPC G06N 3/063

(57) ABSTRACT

A device for processing convolution operations includes: a processor that executes, in a neural network, a convolution operation on input data in a form of width×height×input channel and on a filter in a form of K×K×input channel or K×K to correspond to a form of the input data, K being an integer greater than or equal to one, and that generates output data in a form of width×height×output channel; and a reader that sequentially reads, from a memory storing the input data, a data group having more pieces of data than unit data throughput of an operator, and provides the data group to the operator to reuse at least one piece of data constituting the data group in the convolution operation. The processor executes, by using one or more operators identical to the operator, the convolution operation multiple times based on the unit data throughput.

### TECHNICAL FIELD

The present invention relates to a method and device for processing convolution operation of a neural network processor, and more particularly, to a convolution operation method and device capable of increasing a processing speed and efficiency of a convolution operation by reusing data read from a memory several times for the convolution operation in the convolution operation in a neural network.

### BACKGROUND ART

An artificial neural network (ANN) implements artificial intelligence by connecting artificial neurons that are mathematically modeled on neurons that make up a human brain. A deep neural network (DNN), which is a form of artificial neural network (ANN), is an ANN that includes multiple hidden layers between an input layer and an output layer, and has network architecture in which artificial neurons (nodes) are layered. According to the algorithm, examples of the deep network may include a deep belief network (DBN), a deep autoencoder, and the like based on an unsupervised learning method, a convolutional neural network (CNN) for processing image data, a recurrent neural network (RNN) for processing time series data, and the like.

Among them, the CNN is a form of the DNN and refers to a DNN including one or more convolution layers among layers of a neural network constituting the DNN. The convolution layer is a layer that calculates output activation by applying a filter having the form of K×K×input channel to each input activation when the input activations are configured in the form of width×height×input channel. In general, there are as many filters as there are output channels, and a size of the filter has the form of K×K×input channel×output channel.

The convolution operation performed in the convolution layer has a slightly different operation method depending on a padding or stride method, in which the padding means adding 0 or any number of pads to a boundary of input activation or not adding a pad thereto, and the stride means an interval between input activation points where the convolution operation is performed. In the simple form, when “Stride=1, Padding=Same,” the size of the output activation is width×height×output channel.

Meanwhile, since the convolution operation occupies 90% or more of a total network operation in the CNN, increasing the speed and efficiency of the convolution operation is an important factor in increasing performance and energy efficiency of a deep learning accelerator. Here, the deep learning accelerator is a term representing a processor specialized in an operation of nodes constituting the DNN.

Conventionally, when k×k convolution is performed on an input activation such as a tensor, which is a three-dimensional input, one activation constituting an input tensor needs to be used K² times for output calculation, so the corresponding activation was read K² times from a memory and the convolution operation was processed. However, when one activation is read K² times to process the convolution operation, the number of instances of reading the memory (e.g., a static random access memory (SRAM)) in which the activation is stored increases, thereby causing a problem that unnecessary energy is consumed. In addition, in this case, due to a limited memory read bandwidth (e.g., SRAM read bandwidth), a bottleneck occurs in an activation read speed, thereby causing a problem in that the speed of the convolution operation is lowered.

In addition, most of the conventional deep learning accelerators are optimized for a specific input depending on the form of the input/output tensor for the convolution operation, the size of the filter, and convolution parameters. In the convolution operation to which various types of input/output tensors, the size of the filter, and the convolution parameters are applied like the above-described DNN, the conventional deep learning accelerator has a problem in that a data reuse rate for types of input other than the specific type is lowered, thereby causing a problem in that the processing performance and efficiency of the accelerator are lowered.

### DISCLOSURE

### Technical Problem

The present invention is directed to providing a method and device for processing a convolution operation capable of increasing a processing speed and efficiency of a convolution operation by reusing data read from a memory for the convolution operation several times in the convolution operation in a neural network.

Objects of the present invention are not limited to the above-described objects. That is, other objects that are not described may be obviously understood by those skilled in the art to which the present invention pertains from the following description.

### Means for Solving Problem

One aspect of the present invention provides a device for processing a convolution operation configured to, in a neural network, process a convolution operation of input data configured in a form of width×height×input channel and a filter formed in a form of K×K×input channel or K×K (wherein K is an integer greater than or equal to one) so as to correspond to a form of the input data so as to generate output data configured in a form of width×height×output channel, the device including: a fetch unit (i.e., a reader) configured to sequentially read, from a memory storing the input data, a data group having more pieces of data than unit data throughput of an operator and provide the data group to the operator so that at least one piece of data among the data constituting the data group is reused for the convolution operation; and an operation unit (i.e., a processor) configured to perform, by using one or more operators identical to the operator, the convolution operation on the data constituting the data group and the filter multiple times according to the unit data throughput.

The fetch unit may include a convolution feed module (i.e., a convolution feeder) and a convolution sequencer module (i.e., a convolution sequencer) including an input data queue and a shift buffer, and the convolution feed module may sequentially read the data group having more pieces of data than the unit data throughput of the operator from the memory storing the input data under control of the convolution sequencer module and store the read data group in the input data queue, and transmit one specific data group among data groups stored in the input data queue to the shift buffer.

The convolution sequencer module may control a data array having the same data amount as the unit data throughput of the operator to be transmitted from the shift buffer to the operation unit, and control another data array having the same data amount as the unit data throughput of the operator but different from the data array to be transmitted from the shift buffer to the operation unit, and the data array and another data array may correspond to a sequential part of the data constituting the one specific data group and may be configured to have the same data part and different data parts as and from each other.

The operation unit may perform the convolution operation of each data array transmitted from the shift buffer and the filter by using the operator so that at least one piece of data constituting the one specific data group is reused.

The convolution sequencer module may include: an iterative sequencer configured to control data groups stored in input data queue to be sequentially transmitted to the shift buffer and control the data arrays of data groups stored in the shift buffer to be transmitted to the operation unit so as to control at least any one piece of data constituting the data group stored in the input data queue to be reused in the convolution operation; and a control sequencer configured to control iterative sequencer for data groups, which have more pieces of data than the unit data throughput of the operator and are different from the data groups stored in the input data queue to be sequentially read from the memory storing the input data and store the read data groups in the input data queue when a control completion notification for the data groups stored in the input data queue is received (or issued) from the iterative sequencer, and control the iterative sequencer to execute control of the different data groups.

An amount of data in the data array may be the same as UnitSize(#MAC) which is the unit data throughput of the operator, and an amount of data in the data group may be defined by a formula {floor(K/2)+UnitSize(#MAC)+floor(K/2)} or more obtained by adding floor(K/2), which is a maximum integer value of K/2, to the UnitSize(#MAC), which is the unit data throughput of the operator, twice, where K is a constant determined according to the form of the filter K×K×input channel or K×K and is an integer greater than or equal to one.

Another data array may be a data array of an area shifted according to a preset standard from the data array in the data group of the shift buffer.

The number of data arrays controlled to be transmitted from the shift buffer to the operation unit for the one specific data group by the convolution sequencer module may be K, and as the convolution operation of the filter is performed K times for each data array transmitted from the shift buffer by the operator, the number of times data of the one specific data group is used may be K² times.

The device for processing a convolution operation may further include a commit unit (or a commit device) that transforms result data calculated by the operation unit into a preset form and stores the data in the memory.

The fetch unit may further include a fetch buffer from which data stored in the memory is fetched (or taken), a fetch sequencer controlling data to be fetched from the memory to the fetch buffer, and a fetch network transmitting the fetched data to the convolution feed module.

Another aspect of the present invention provides a method of processing a convolution operation using a device for processing a convolution operation configured to, in a neural network, process a convolution operation of input data configured in a form of width×height×input channel and a filter formed in a form of K×K×input channel or K×K (wherein K is an integer greater than or equal to one) so as to correspond to a form of the input data so as to generate output data configured in a form of width×height×output channel, the method including: sequentially reading, by a fetch unit of the device for processing a convolution operation, a data group having more pieces of data than unit data throughput of an operator from a memory storing the input data and fetching the data group to the operator so that at least one piece of data among the data constituting the data group is reused for the convolution operation; and operating, by the operation unit of the device for processing a convolution operation, the convolution operation of the data constituting the data group and the filter multiple times using one or more operators identical to the operator according to the unit data throughput.

The fetch unit may include a convolution feed module and a convolution sequencer module including an input data queue and a shift buffer, and the fetching may include: sequentially reading, by the convolution feed module, the data group having more pieces of data than the unit data throughput of the operator from the memory storing the input data under control of the convolution sequencer module and storing the read data in the input data queue; and transmitting, by the convolution feed module, one specific data group among data groups stored in the input data queue to the shift buffer under the control of the convolution sequencer module.

The fetching may further include: controlling the convolution sequencer module to transmit a data array having the same data amount as the unit data throughput of the operator from the shift buffer to the operation unit; and controlling the convolution sequencer module to transmit another data array having the same data amount as the unit data throughput of the operator but different from the data array from the shift buffer to the operation unit, and the data array and another data array correspond to a sequential part of the data constituting the one specific data group and are configured to have the same data part and different data parts as and from each other.

The operating may include performing, by the operation unit, the convolution operation of each data array transmitted from the shift buffer and the filter by using the operator so that at least one piece of data constituting the one specific data group is reused.

The convolution sequencer module may include an iterative sequencer, and the fetching may include: controlling the iterative sequencer to sequentially transmit data groups stored in the input data queue to the shift buffer; controlling the iterative sequencer to transmit data arrays of data group stored in the shift buffer to the operation unit; and controlling the iterative sequencer to reuse at least any one piece of data constituting the data group stored in the input data queue in the convolution operation.

The convolution sequencer module may further include a control sequencer, and when a control completion notification for the data groups stored in the input data queue is received (or issued) from the iterative sequencer, the fetching may include: controlling the control sequencer to sequentially read data groups, which have more pieces of data than the unit data throughput of the operator and are different from the data groups stored in the input data queue, from the memory storing the input data and storing the read data groups in the input data queue; and controlling the iterative sequencer to execute control of the different data groups.

An amount of data in the data array may be the same as UnitSize(#MAC) which is the unit data throughput of the operator, and an amount of data in the data group may be defined by a formula {floor(K/2)+UnitSize(#MAC)+floor(K/2)} or more obtained by adding floor(K/2), which is a maximum integer value of K/2, to the UnitSize(#MAC), which is the unit data throughput of the operator, twice, where K is a constant determined according to the form of the filter K×K×input channel or K×K and is an integer greater than or equal to one.

Another data array may be a data array of an area shifted according to a preset standard from the data array in the data group of the shift buffer.

The number of data arrays controlled to be transmitted from the shift buffer to the operation unit for the one specific data group by the convolution sequencer module may be K, and as the convolution operation of the filter are performed K times for each data array transmitted from the shift buffer by the operator, the number of times data of the one specific data group is used may be K² times.

### Advantageous Effects

According to the present invention, data read from an input in a convolution operation in a neural network may be reused in the convolution operation to increase a data reuse rate, thereby increasing the processing speed and efficiency of the convolution operation.

In addition, according to the present invention, it is possible to provide a device for processing a programmable convolution operation to be able to sequentially put data sequentially read from the memory into a multiply-accumulate (MAC) unit several times according to operation characteristics, thereby increasing the processing speed and efficiency of complex operations such as convolution in an operation module including a large number of MAC units that perform a multiply-accumulate operation.

In addition, according to the present invention, it is possible to implement a device for processing a programmable convolution operation to be able to reduce energy used for reading of a memory by reducing the number of instances of reads of the memory, maximize a utilization rate of a large number of MAC units by using a preset memory data bandwidth, and achieve high performance and energy efficiency of various types of input tensors and convolution parameters.

It should be understood that the effects of the present invention are not limited to the above effects, and all effects that can be inferred from the configuration of the invention described in the detailed description or claims of the present invention are included.

### DESCRIPTION OF DRAWINGS

FIG. 1 is a block diagram schematically illustrating a configuration of a device for processing a convolution operation according to an embodiment of the present invention.

FIG. 2 is a diagram illustrating a detailed configuration of the device for processing a convolution operation of FIG. 1.

FIG. 3 is a diagram illustrating, in detail, detailed configurations of a fetch unit of FIG. 1.

FIG. 4 is a conceptual diagram illustrating a method of performing a convolution operation using the device for processing a convolution operation to the embodiment of the present invention.

FIGS. 5 to 17 are diagrams illustrating a detailed process in which convolution operation processing is performed according to the embodiment of the present invention.

FIG. 18 is a flowchart illustrating procedures of a method of processing a convolution operation according to the embodiment of the present invention.

FIG. 19 is a flowchart for describing detailed procedures of a fetch process and a calculation operation illustrated in FIG. 18.

FIG. 20 is a diagram for describing detailed procedures performed by a convolution sequencer module of the present invention.

### MODES OF THE INVENTION

Hereinafter, embodiments of the present invention will be described in detail with reference to the accompanying drawings. However, the present invention may be implemented in several different forms and is not limited to embodiments provided in the present specification. Further, it should be understood that the accompanying drawings are provided only in order to allow exemplary embodiments of the present invention to be easily understood, and the spirit of the present invention is not limited by the accompanying drawings but includes all the modifications, equivalents, and substitutions included in the spirit and the scope of the present invention. And, in order to clearly describe the present invention in the drawings, parts irrelevant to the descriptions are omitted, and sizes, forms, and shapes of each component illustrated in the drawings may be variously modified, and same/similar reference numerals are attached to the same/similar parts throughout the entire specification.

In addition, terms “module” and “unit” for components used in the following description are used only to easily make the invention. Therefore, these terms do not have meanings or roles that distinguish from each other in themselves. Further, when it is decided that a detailed description for the known art related to the present invention may obscure the gist of the present invention, the detailed description will be omitted.

Throughout the present specification, when any one part is referred to as being “connected (joined, contacted, and coupled) to” another part, it means that any one part and another part are “directly connected (joined, contacted, and coupled) to” each other or are “indirectly connected (joined, contacted, and coupled) to” each other with still another part interposed therebetween. In addition, unless explicitly described to the contrary, “including (comprising or providing)” any component will be understood to imply including (comprising or providing) other components rather than the exclusion of other components.

Terms used in the present specification are used only in order to describe specific exemplary embodiments rather than limiting the present invention. The singular expression includes a plural expression unless the context clearly indicates otherwise, and components implemented in a dispersed form may be implemented in a combined form unless there is a special limitation. It will be understood that terms ‘include’ or ‘have’ used in the present specification specify the presence of features, numerals, processes, operations, components, parts described in the present specification, or a combination thereof but do not preclude the presence or addition of one or more other features, numerals, processes, operations, components, parts, or a combination thereof.

Terms including an ordinal number, such as first, second, or the like, used in the present specification may be used to describe various components. However, these components are not limited to these terms. The terms are used only to distinguish one component from another component. For example, a “first” component may be named a “second” component and the “second” component may also be similarly named the “first” component without departing from the scope of the present invention.

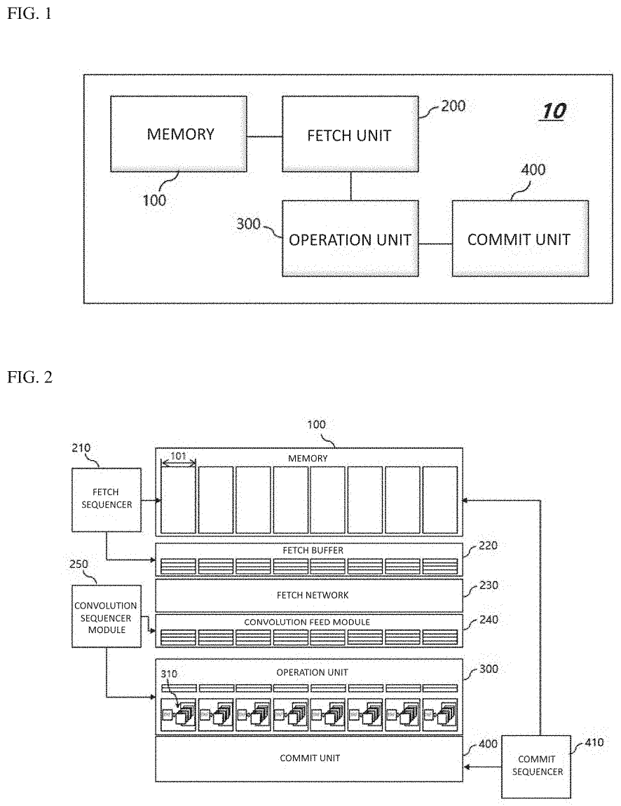

FIG. 1 is a block diagram schematically illustrating a configuration of a device for processing a convolution operation according to an embodiment of the present invention.

As illustrated in FIG. 1, a device 10 for processing a convolution operation may be configured to include a memory 100, a fetch unit (i.e., reader) 200, an operation unit (i.e., processor) 300, and a commit unit 400. However, as illustrated in FIG. 1, the device 10 for processing a convolution operation does not necessarily have to be configured in a form including all of the memory 100, the fetch unit 200, the operation unit 300, and the commit unit 400. For example, the memory 100 and the commit unit 400 may be disposed outside of the device 10 for processing a convolution operation.

The memory 100 is a device for storing data used for the convolution operation according to the embodiment of the present invention, in which the data may be data in the form of tensor, which is three-dimensional (3D) input as an example. The memory 100 may be formed in the form of a data memory such as a static random access memory (SRAM) but is not necessarily formed in this form. Referring to FIG. 2, the memory 100 may be configured to have a preset read bandwidth 101.

The fetch unit 200 reads data required for the convolution operation from input data stored in the memory 100 and provides the read data to the operation unit 300. When the input data is a tensor, the fetch unit 200 may read the tensor stored in the memory 100 and feed the read tensor to the operation unit 300 according to the form of the operation unit 300. The fetch unit 200 may sequentially read, from the memory 100, a data group having the same number of pieces or more pieces of data than unit data throughput of one or more operators provided in the operation unit 300 and feed the read data group to the operation unit 300. Here, the operator may be configured in the form of a general multiply-accumulate (MAC).

The operation unit 300 processes the input data transmitted from the fetch unit 200 and the convolution operation of the filter to form an output. The operation unit 300 is configured according to (corresponding to) the type of operation to be performed and processes data fed from the fetch unit 200 in a streaming manner. The operation unit 300 may include one or more operators. Such an operator may be configured as a MAC that performs a multiply-accumulate operation and may perform the convolution operation of the input data and a filter under the control of the convolution sequencer module 250.

The commit unit 400 stores the operation result output from the operation unit 300 in a streaming manner in the memory 100. The commit unit 400 may transform an output calculated by the operation unit 300 into a form required for the next operation and store the output in the memory 100. In other words, the commit unit 400 may transform result data calculated by the operation unit 300 into a preset form and store the result data in the memory 100.

FIG. 2 is a diagram illustrating a detailed configuration of the device for processing a convolution operation of FIG. 1. The memory 100, fetch unit 200, operation unit 300, and commit unit 400 will be described in more detail with reference to FIG. 2.

The memory 100 may be configured to store at least any one piece of data among the data described herein. For example, the memory 100 may store input data, a tensor, an output data, a filter, operation result data of an operation unit, all data used in a fetch unit, or the like to be described below.

The fetch unit 200 includes a fetch sequencer 210 that controls data to be fetched from the memory 100 to the fetch buffer 220, a fetch buffer 220 from which data stored in the memory 100 is fetched, a fetch network 230 that transmits the fetched data to a convolution feed module 240, a convolution feed module (i.e., a convolution feeder) 240 to which the input data is fed, and a convolution sequencer module (i.e., a convolution sequencer) 250 that controls the input data fed for the convolution operation so that the operation unit 300 performs the operation.

The fetch unit 200 processes and controls the data constituting the data group so that at least any one piece of data among the data constituting the data group is reused for the convolution operation several times in the operation unit 300.

The fetch unit 200 may generate output data by allowing each of the plurality of MACs included in the operation unit 300 to perform the convolution operation of the data constituting the data group and the filter according to their unit data throughput at least once.

The operation unit 300 may include a plurality of dot product engines 310 that may perform parallel processing and include, for example, 256 dot product engines 310. Here, the dot product engine 310 may be configured to include one or more operators, that is, MAC.

With respect to the dot product engine 310, the fetch unit 200 may serve to read data from the memory 100 and feed the read data to the dot product engine 310 of the operation unit 300. The convolution operation described herein may be performed in the dot product engine 310 that performs the dot product using a plurality of MACs (e.g., 32 MACs).

In addition, the memory 100 may be configured as a column-dimensional continuous memory address space, and an internal structure of the memory 100 may be configured as an independently accessible slice structure. For example, the memory 100 may include a plurality of data memory slices. In this case, the number of slices may be the same as the number of dot product engines 310 included in the operation unit 300. For example, the tensors that are the input data may be separately stored in the slice.

The device 10 for processing a convolution operation may be configured to, in a neural network, process a convolution operation of input data configured in a form of “width×height×input channel” and a filter formed in a form of “K×K×input channel” or “K×K” (wherein K is an integer greater than or equal to one) so as to correspond to a form of the input data so as to generate output data configured in a form of “width×height×output channel.” Hereinafter, for convenience of description, a case in which the input data is a three-dimensional tensor having height×width×channel is described as an example.

In this case, the tensor may be sliced in the channel direction and the height direction and stored in the memory 100. For example, a tensor composed of 167 data memory slices and four channels may be divided into four pieces in a height direction of each channel, and each of 16 pieces of divided data may be stored in 16 data memory slices. The dot product engine 310 of the operation unit 300 may also be divided in the height direction of the channel and perform a multiply-accumulate operation to generate output activation.

In the case of two-dimensional (2D) convolution, values of all the input channels need to be input to the dot product engine 310 that calculates each output activation. Accordingly, the fetch unit 200 feeds the input activation values sequentially read in the channel direction to the dot product engine 310 in a broadcast manner. In addition, the fetch unit 200 uses the fetch sequencer 210 to sequentially read data to be input from each input tensor slice to the operation unit 300. Each piece of data read in the memory slice by the fetch sequencer 210 is transmitted to the operation unit 300 through the fetch network 230 of the fetch unit 200.

The fetch network 230 of the fetch unit 200 may have a different structure according to a tensor operation and a tensor shape. That is, the fetch network 230 may be configured by software in a topology of a type required by the operation unit 300. In addition, the fetch network 230 determines the topology according to the type of the input tensor and the type of the operation unit 300 and supports communication types such as Direct, Vertical Broadcast, Channel Broadcast, and Vertical Nearest Neighbor according to the tensor operation performed.

In this way, the fetch unit 200 may serve to read tensor slices from the memory 100 in parallel and feed the tensor slices to the operation unit 300 in the form that the operation unit 300 may operate the tensor slices. Here, the fetch network 230 may further include a fetch network controller (not illustrated) that configures and manages the fetch network 230 to transmit data read from the memory 100 to the operation unit 300 that requires the data.

As described above, the commit unit 400 may transform an output activation calculated by the operation unit 300 into a form required for the next operation and store the output activation in the memory 100.

For example, in the neural network, the commit unit 400 may store the output activation in the memory so that the output activation according to an operation in a specific hierarchical layer may be used for an operation in a next layer. In addition, according to the form of the tensor required for the tensor operation of the next layer, the commit unit 400 may perform tensor manipulation such as transposing and may transmit and store the results to the memory 100 through the commit network (not illustrated).

As such, the commit unit 400 stores the output tensor in the memory 100 in the desired form after the operation unit 300 performs the tensor operation. To store the output tensor in the desired form, the commit unit 400 may perform the tensor transpose using a tensor transpose module (not illustrated), a commit network module (not illustrated), and a commit sequencer 410.

In addition, the dot product engine 310 uses an input tensor input from the fetch unit 200 as an operand for calculating a MAC, a register value input from a tensor register file located in the dot product engine 310, and an accumulation value input from the accumulator. Then, the operation result is stored in the accumulator again or transmitted to the commit unit 400 to be stored in the memory 100 as an output tensor.

In an embodiment of the present invention, the dot product engine 310 may accumulate a product of a weight and activation as a combination of a temporal accumulation and a spatial sum. For example, the dot product engine 310 may be composed of a MAC of 32 columns having a plurality of accumulators and a 32-to-1 adder tree. Here, the accumulator performs accumulation as much as set by an accumulation count register and performs temporal accumulation as the accumulator transmits the result to the adder tree for each accumulation count. In addition, the adder tree is configured by a spatial sum depth register so that the result of the adder tree of the corresponding depth may be output to an output buffer.

In addition to the dot product engine 310, the operation unit 300 may further include a register file (not illustrated), a register indexer (not illustrated), a register network module (not illustrated), and an accumulator indexer (not illustrated). The register file is a storage space for temporarily storing one of relatively frequently used or reused operators when the dot product engine 310 performs the MAC operation. For example, the register file may be configured in the form of the SRAM.

When performing the convolution operation in the neural network according to the embodiment of the present invention, in the case of a general convolution layer having a large activation size, the weight may be stored in the register file and the activation may be stored in the memory. In addition, in the case of a fully connected layer having a larger weight compared to the activation size, the weight may be stored in the memory and the activation may be stored in the register file.

The register indexer designates a register to be fed to the dot product engine 310 in the register file and may be implemented in the form of a sequencer.

The register network module transmits the register value designated and read by the register indexer in the register file to the dot product engine 310. Depending on the type of operation, such as the convolution or the fully connected layer, a single register value may be broadcast to all MACs, or different register values may need to be transmitted to each MAC. In addition, when a horizontal stride is two or more in the convolution operation, the register value may need to be broadcast to the entire MAC in two units depending on the method of performing the operation. The register network module enables a type of connection that transmits registers to be configured by software.

The accumulator indexer specifies the index of the accumulator to be fed from the accumulator to the MAC and may be implemented in the form of the sequencer.

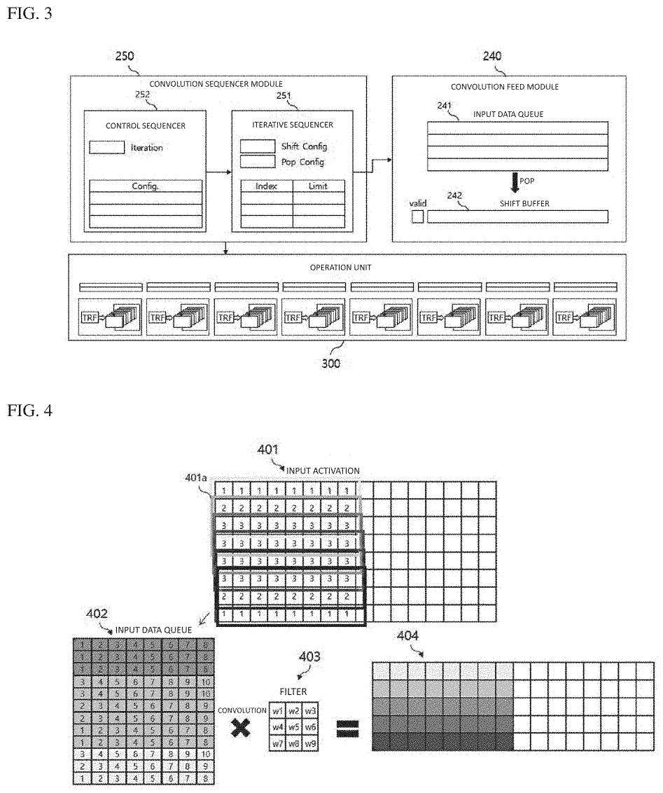

FIG. 3 is a diagram illustrating, in detail, detailed configurations of the fetch unit of FIG. 1.

As illustrated in FIG. 3, the convolution feed module 240 may include an input data queue 241 and a shift buffer 242.

The input data queue 241 is a queue in which the data groups sequentially read from the data stored in the memory 100 by the convolution feed module 240 are stored.

The shift buffer 242 is a buffer in which one specific data group among data groups input to the input data queue 241 is stored and performs a shift for reuse of data.

Also, as illustrated in FIG. 3, the convolution sequencer module 250 may include an iterative sequencer 251 and a control sequencer 252.

The iterative sequencer 251 controls the data groups stored in the input data queue 241 to be sequentially transmitted to the shift buffer 242. In addition, the iterative sequencer 251 controls the data arrays of the data group stored in the shift buffer 242 to be transmitted to the operation unit 300 so that the operator controls the convolution operation of the filter and the data arrays to be performed.

For example, the iterative sequencer 251 may control the shift buffer 242 to control the shift buffer 242 to perform shifting or buffering. Through this, the iterative sequencer 251 controls at least any one piece of data among data constituting the data group stored in the input data queue 241 to be reused in the convolution operation.

In addition, when data processing controlled by the iterative sequencer 251 is finished, the iterative sequencer 251 may notify the control sequencer 252 of the fact.

The control sequencer 252 controls data groups, which have more pieces of data than the unit data throughput of the operator and are different from the data groups stored in the input data queue 241, to be sequentially read from the memory 100 storing the input data and store the read data groups in the input data queue 241 when the control completion notification for the data groups stored in the input data queue 241 is received (or issued) from the iterative sequencer 251. In addition, the control sequencer 252 controls the iterative sequencer 251 to execute the control of the different data groups.

Through this, the control sequencer 252 controls the iterative sequencer 251 to execute the control of the new data groups. That is, under the control of the control sequencer 252, the iterative sequencer 251 controls the convolution operation to repeatedly reuse data of data groups.

For example, the control sequencer 252 may control components necessary for the control of the iterative sequencer 251 to be executed so that the procedure performed by the iterative sequencer 25 is repeated. Accordingly, after the iterative sequencer 25 executes a given procedure, the control sequencer 252 may control the iterative sequencer 25 to execute the next procedure so as to repeat the same procedure.

FIG. 4 is a conceptual diagram illustrating a method of performing a convolution operation using the device 10 for processing a convolution operation to the embodiment of the present invention. A schematic process of convolving the input data and the filter and generating the output data using the device 10 for processing a convolution operation will be described with reference to the above description and FIG. 4.

Referring to FIG. 4, the data group described herein means each of the data groups 401a having the form of 3 (height)×8 (width) of the input activation 401, and reference numeral 402 denotes a state in which each of the read data groups is inputted into the input data queue and completed. In addition, the filter 403 convolutionally operated with the input data may be configured in various matrix types having a plurality of unit weights.

Referring to FIGS. 3 and 4, in order to generate the output data by convolving the input data and the filter, first, under the control of the convolution sequencer module 250, the convolution feed module 240 sequentially reads the data group having more pieces of data than the unit data throughput of the MAC of the operation unit 300 from the input data stored in the memory 100 and stores the read data group 401a in the input data queue 402.

Next, under the control of the convolution sequencer module 250, the convolution feed module 240 transmits one specific data group among the data groups stored in the input data queue 402 to the shift buffer 242.

Next, the convolution sequencer module 250 controls the data array having the same data amount as the unit data throughput of the operator to be transmitted from the shift buffer 242 to the operation unit 300.

Next, the convolution sequencer module 250 controls another data array, which has the same data amount as the unit data throughput of the operator for data reuse but is slightly different from the data array due to the data shift, to be transmitted from the shift buffer 242 to the operation unit 300.

The data array and another data array correspond to a sequential part of data constituting the one specific data group. However, the data array and another data array are configured to have the same data part and different data parts due to the above-described data shift.

Next, the operation unit 300 performs the convolution operation of each of the data arrays transmitted from the shift buffer 242 and the filter so that at least one piece of data among the data constituting the one specific data group is reused.

In the above process, the amount of data in the data array may be the same as UnitSize(#MAC) which is the unit data throughput of the operator, and the amount of data in the data group may be defined by a formula {floor(K/2)+UnitSize(#MAC)+floor(K/2)} or more obtained by adding floor(K/2), which is a maximum integer value of K/2, to the UnitSize(#MAC), which is the unit data throughput of the operator, twice. That is, the amount of data in the data group may be {floor(K/2)+UnitSize(#MAC)+floor(K/2)} or more depending on the hardware configuration of the fetch unit, the operation unit, and the like.

In this case, the number of data arrays transmitted from the shift buffer 242 to the operation unit 300 is K, and the operation unit 300 performs the convolution operation of the filter K times for each data array transmitted from the shift buffer 242.

In other words, the number of data arrays controlled by the convolution sequencer module 250 to be transmitted from the shift buffer 242 to the operation unit 300 for the one specific data group is K. In addition, the operation unit 300 performs the convolution operation of the filter K times for each data array transmitted from the shift buffer 242. Accordingly, the number of times data of the one specific data group is used is K² times.

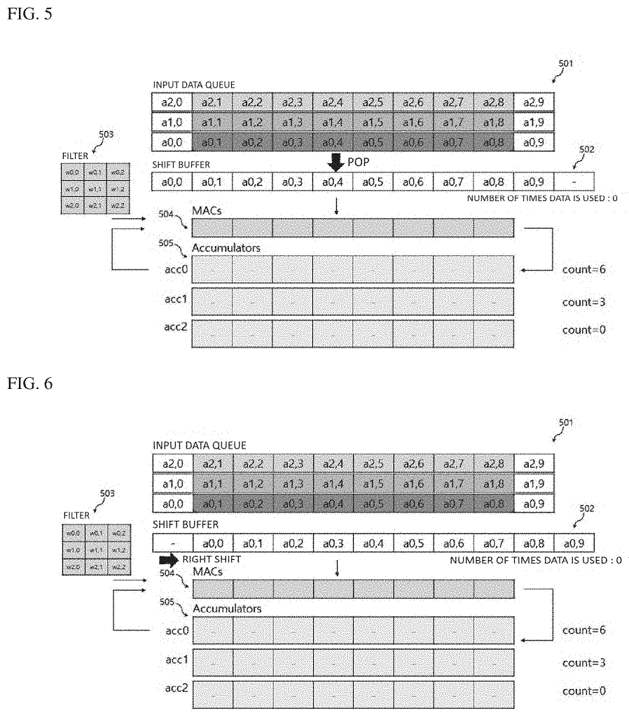

FIGS. 5 to 17 are diagrams for describing detailed processes in which the convolution operation processing is performed so that data is reused by the convolution feed module 240 and the convolution sequencer module 250 according to the embodiment of the present invention. As in the example shown in FIGS. 5 to 17, a process in which the fetch unit 200 and the operation unit 300 described above use a data group including ten pieces of unit data and a 3×3 type of filter to convolve a data array including eight pieces of unit data and the corresponding filter will be sequentially described in detail.

In this example, a width of each of the accumulators 505 corresponding to the unit data throughput of the operator is reduced by one space farther left and right than a width of an input data queue 501. This is because the output value according to the convolution operation decreases according to a size of a filter 503.

As described above, in this example, the amount of data in the data array may be the same as UnitSize(#MAC), which is the unit data throughput of the operator, and the amount of data in the data group may be defined by a formula {floor(K/2)+UnitSize(#MAC)+floor(K/2)} or more obtained by adding floor(K/2), which is a maximum integer value of K/2, to the UnitSize(#MAC), which is the unit data throughput of the operator, twice.

Here, K is a constant determined according to the type of filter K×K and is an integer greater than or equal to one. Therefore, in this example, since the data array is configured to include eight pieces of unit data, the data group is additionally composed of data shifted by floors (3/2) to the left and right of the data array. As a result, in this example, since the amount of pieces of data in the data array is eight and K is three, the amount of data in the data group is “1+8+1=10.”

Also, in this example, it is assumed that some repetitive operations have already been performed, such as acc0 and acc1, and therefore, it is assumed that counts of acc0 and acc1 are 6 and 3, respectively. In addition, the operation unit 300 includes a plurality of MACs, but for convenience of description, only a convolution operation performed in a single MAC will be described.

Referring to FIG. 5, first, the convolution feed module 240 sequentially reads data groups having more pieces of data than unit data throughput of MACs 504 from the data of the input tensor stored in the memory 100 under the control of the convolution sequencer module 250 and stores the read data in the input data queue 501

Next, the convolution feed module 240 pops a data group of a lowest layer including unit data a0,0, a0,1, . . . , and a0,9 according to a preset order in the input data queue 501 under the control of the convolution sequencer module 250 and transmits the popped data group to the shift buffer 502 for storage. Here, when there is no empty space in the input data queue 501, the data group of the lowest layer may be popped and transmitted to the shift buffer 502.

Referring to FIG. 6, the convolution feed module 240 shifts pieces of unit data included in the shift buffer 502 to the right by one (=floor(K/2)=floor(3/2)) under the control of the convolution sequencer module 250 in order to align the shift buffer 502 and the MAC 504. This process may be omitted when the process of aligning the shift buffer 502 and the MACs 504 is not required.

In FIGS. 5 and 6, since unit data included in the data group is not yet used for the convolution operation, the number of times data is used becomes zero.

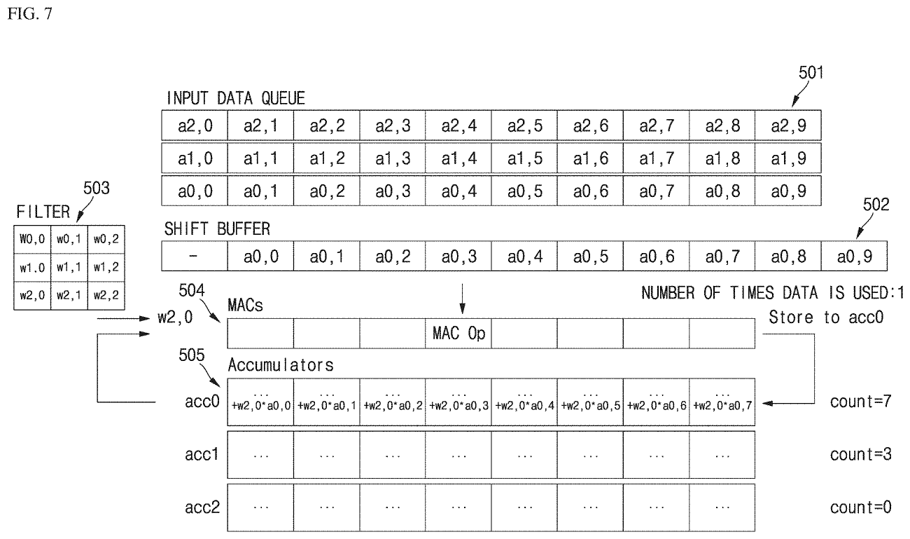

Next, referring to FIG. 7, the convolution sequencer module 250 controls the convolution feed module 240 to provide filter values w2,0 corresponding to the weight required for the operation to the MACs 504, and provide a data array corresponding to the unit data throughput to the MACs 504 from the shift buffer 502 to the MACs 504. Then, the MACs 504 multiply the filter values w2,0 by a0,0 to a0,7 included in the data array and then store results obtained by performing a sum operation with the specified acc0 in the acc0. Here, the filter value may be determined by the register indexer, and the acc0 may be determined by the accumulator indexer.

After such an operation is performed, the number of times the data group in the shift buffer 502 for the convolution operation is used becomes one time. Also, the count corresponding to the number of times accumulated and added to the acc0 increases by one to become seven.

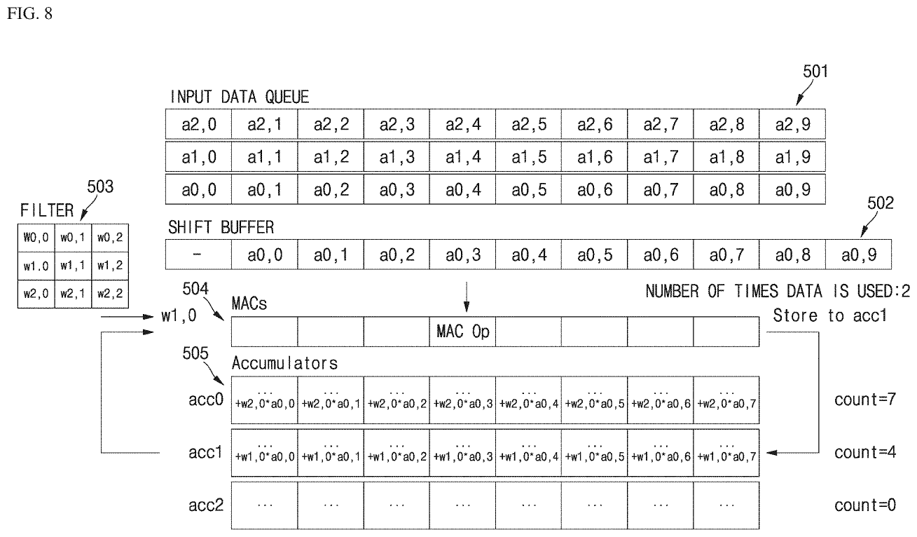

Next, referring to FIG. 8, similar to that described with reference to FIG. 7, the convolution sequencer module 250 controls the convolution feed module 240 to provide filter values w1,0 to the MACs 504 and provide the data array corresponding to the unit data throughput of the MACs 504 to the MACs 504. Then, the MACs 504 multiply the filter values w1,0 by a0,0 to a0,7 included in the data array, and then store results obtained by performing a sum operation with the specified acc1 in the acc1. Here, similarly, the filter value may be determined by the register indexer, and the acc1 may be determined by the accumulator indexer.

After such an operation is performed, the number of times the data group in the shift buffer 502 for the convolution operation is used increases by one to become two times. Also, the count corresponding to the number of times accumulated and added to the acc1 increases by one to become four.

The reason for using a plurality of accumulators for the convolution operation is to reuse the data of the data group in the height direction of the filter in the convolution operation. In this example, by using the accumulator corresponding to three, which is the height of the filter 503, for the convolution operation in the rotation method, it is possible to completely reuse the data included in the data group for the filter values of the filter 503.

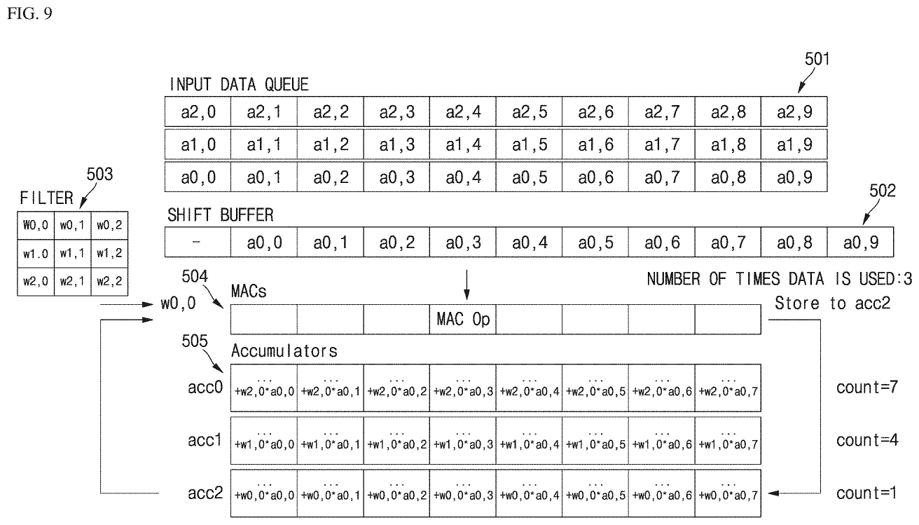

Next, referring to FIG. 9, the convolution sequencer module 250 controls the convolution feed module 240 to provide filter values w0,0 to the MACs 504 and provide a data array corresponding to the unit data throughput of the MACs 504 from the shift buffer 502 to the MACs 504. Then, the MACs 504 multiply the filter values w0,0 by a0,0 to a0,7 included in the data array and then store results obtained by performing a sum operation with the specified acc2 in the acc2.

After such an operation is performed, the number of times the data group in the shift buffer 502 for the convolution operation is used increases by one to become three times. Also, the count corresponding to the number of times accumulated and added to the acc2 increases by one to become one.

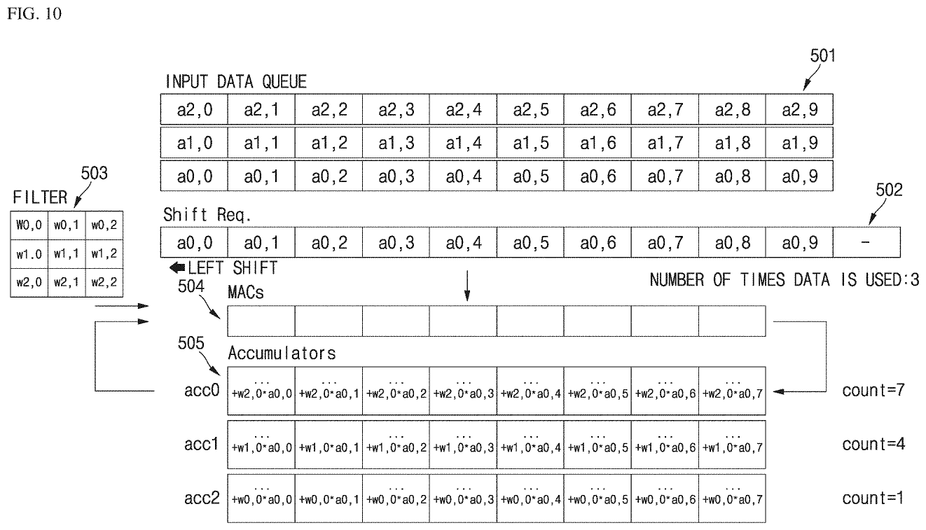

Subsequently, referring to FIG. 10, counts of three accumulators increase by one, respectively, and a first data array (including a0,0 to a0,7) provided from the shift buffer 502 to the MACs 504 and after the operation of the and filter 503 is finished, a second data array including pieces of unit data different from the first data array is provided to the MACs 504. That is, under the control of the convolution sequencer module 250, the shift buffer 502 shifts the stored data groups a0,0 to a0,9 to the left by one space. This is to reuse the data of the data group in the width direction.

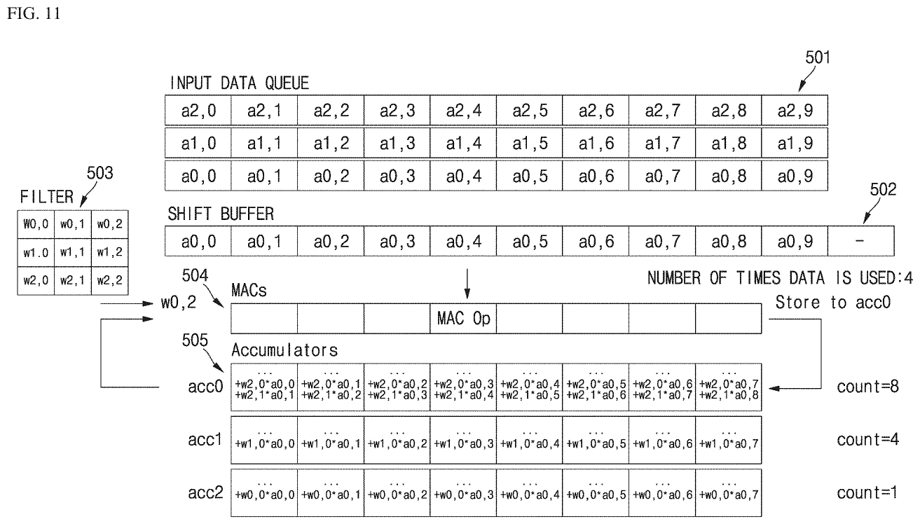

Next, referring to FIG. 11, the convolution sequencer module 250 controls the convolution feed module 240 to provide filter values w2, 1 to the MACs 504 and provide a data array corresponding to the unit data throughput of the MACs 504 from the shift buffer 502 to the MACs 504. Then, the MACs 504 multiply the filter values w2,1 by a0,1 to a0,8 included in the data array and then store results obtained by performing a sum operation with the specified acc0 in the acc0.

Accordingly, the number of times the data group in the shift buffer 502 is used increases by one to become four times, and the count corresponding to the number of times accumulated and added to the acc0 increases by one to become eight.

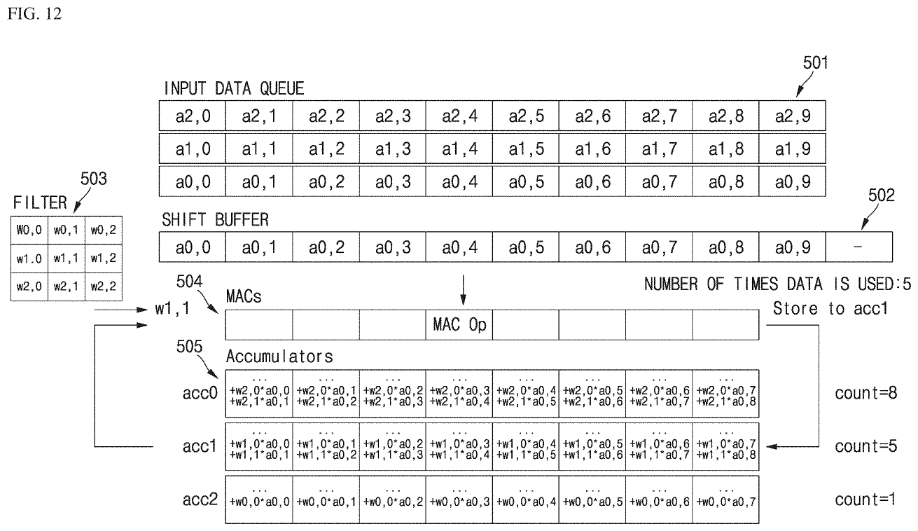

Next, referring to FIG. 12, the convolution sequencer module 250 controls the convolution feed module 240 to provide filter values w1,1 to the MACs 504, and provide a data array corresponding to the unit data throughput of the MACs 504 from the shift buffer 502 to the MACs 504. Then, the MACs 504 multiply the filter values w1,1 by a0,1 to a0,8 included in the data array and then store results obtained by performing a sum operation with the specified acc1 in the acc1.

Accordingly, the number of times the data group in the shift buffer 502 is used increases by one to become five times, and the count corresponding to the number of times accumulated and added to the acc1 increases by one to become five.

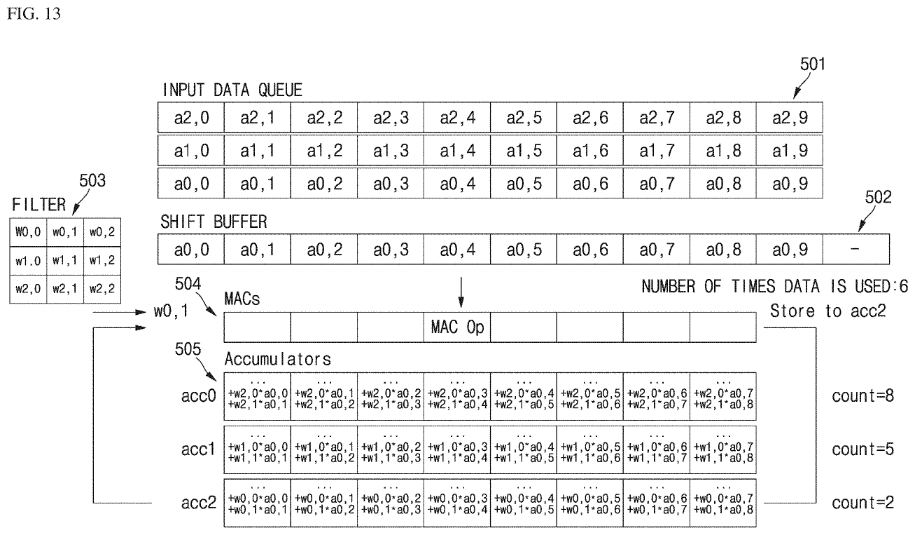

Next, referring to FIG. 13, the convolution sequencer module 250 controls the convolution feed module 240 to provide filter values w0, 1 to the MACs 504 and provide a data array corresponding to the unit data throughput of the MACs 504 from the shift buffer 502 to the MACs 504. Then, the MACs 504 multiply the filter values w0,1 by a0,1 to a0,8 included in the data array and then store results obtained by performing a sum operation with the specified acc2 in the acc2.

Accordingly, the number of times the data group in the shift buffer 502 for the convolution operation is used increases by one to become six times, and the count corresponding to the number of times accumulated and added to the acc2 increases by one to become two.

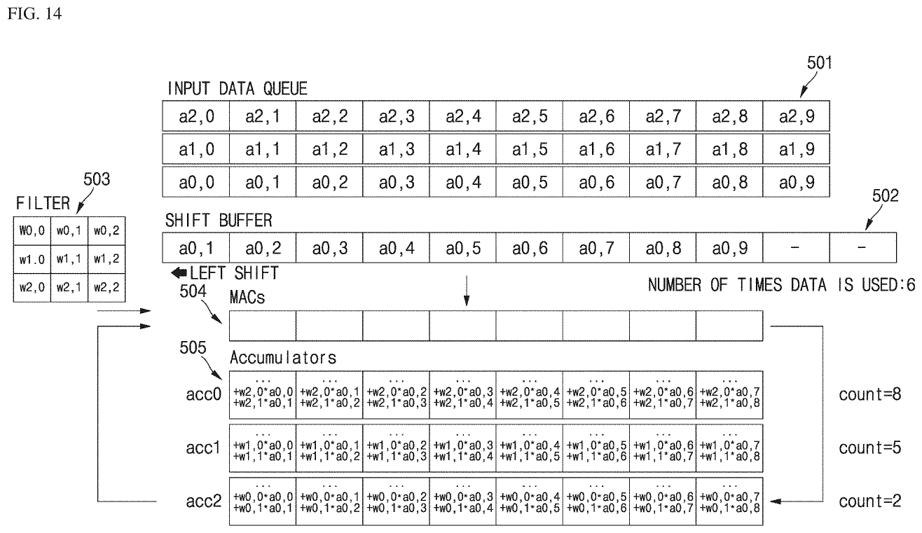

Subsequently, referring to FIG. 14, counts of three accumulators increase by one, respectively, and a second data array (including a0,1 to a0,0) provided from the shift buffer 502 to the MACs 504 and after the operation of the and filter 503 is finished, a third data array including pieces of unit data different from the first and second data arrays is provided to the MACs 504. To this end, under the control of the convolution sequencer module 250, the shift buffer 502 shifts the stored data groups a0,0 to a0,9 to the left by one space.

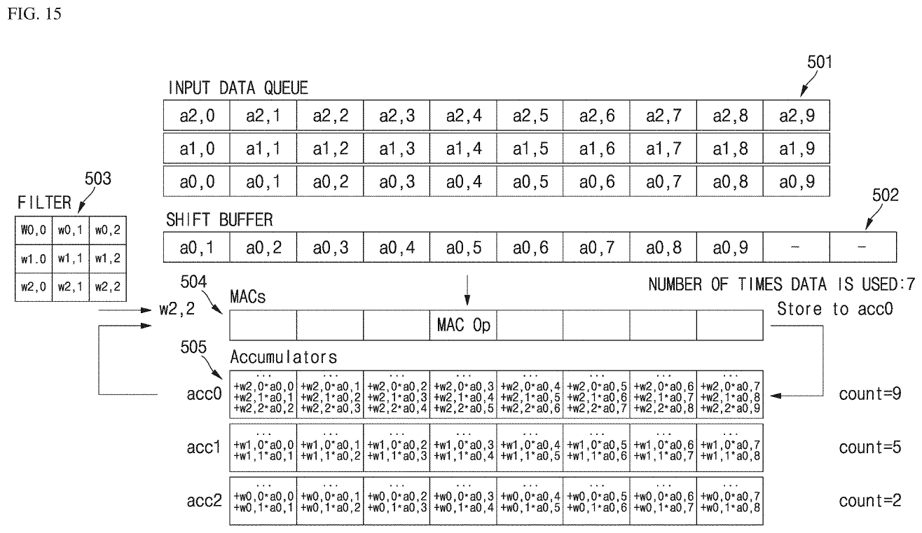

Next, referring to FIG. 15, the convolution sequencer module 250 controls the convolution feed module 240 to provide filter values w2,2 to the MACs 504 and provide a data array corresponding to the unit data throughput of the MACs 504 from the shift buffer 502 to the MACs 504. Then, the MACs 504 multiply the filter values w2,2 by a0,2 to a0,9 included in the data array and then store results obtained by performing a sum operation with the specified acc0 in the acc0.

Accordingly, the number of times the data group in the shift buffer 502 is used increases by one to become seven times, and the count corresponding to the number of times accumulated and added to the acc0 increases by one to become nine.

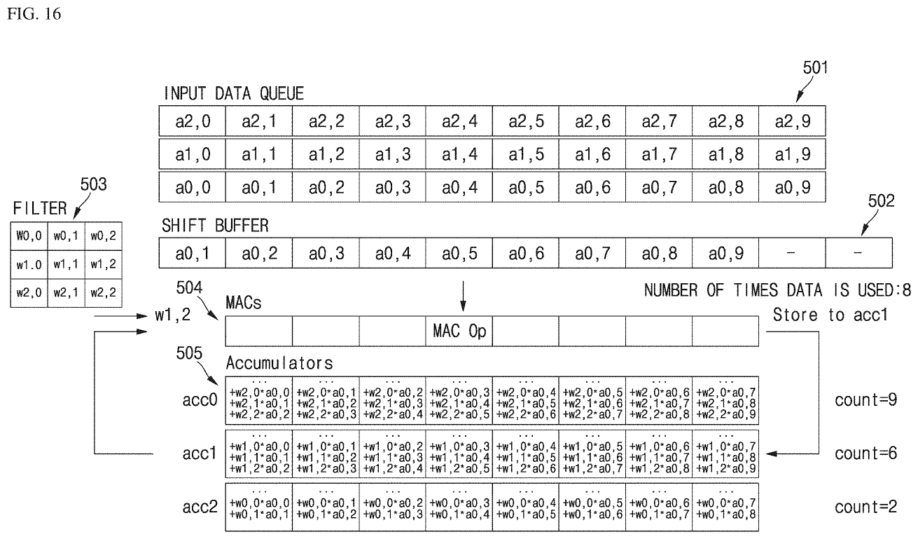

Next, referring to FIG. 16, the convolution sequencer module 250 controls the convolution feed module 240 to provide filter values w1, 2 to the MACs 504 and provide a data array corresponding to the unit data throughput of the MACs 504 from the shift buffer 502 to the MACs 504. Then, the MACs 504 multiply the filter values w1,2 by a0,2 to a0, 9 included in the data array and then store results obtained by performing a sum operation with the specified acc1 in the acc1.

Accordingly, the number of times the data group in the shift buffer 502 is used increases by one to become eight times, and the count corresponding to the number of times accumulated and added to the acc0 increases by one to become six.

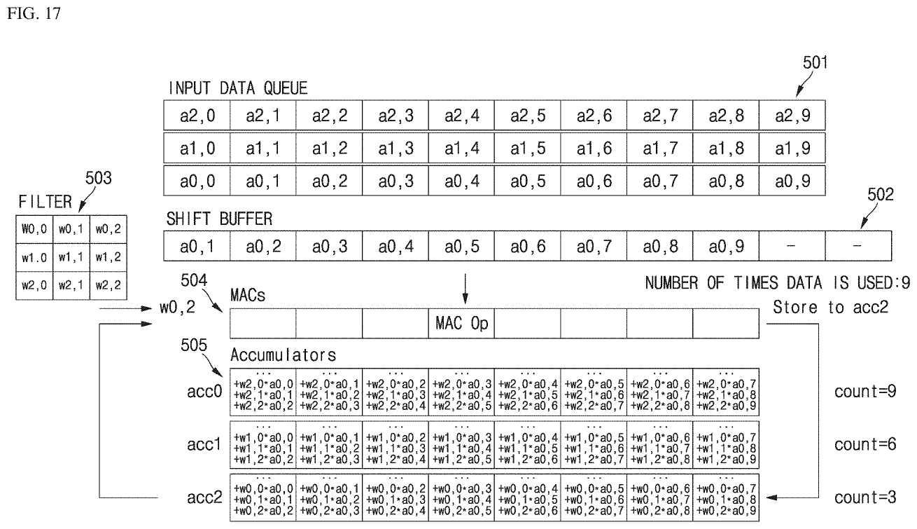

Next, referring to FIG. 17, the convolution sequencer module 250 controls the convolution feed module 240 to provide filter values w0, 2 to the MACs 504 and provide a data array corresponding to the unit data throughput of the MACs 504 from the shift buffer 502 to the MACs 504. Then, the MACs 504 multiply the filter values w0,2 by a0,2 to a0,9 included in the data array and then store results obtained by performing a sum operation with the specified acc2 in the acc2.

Accordingly, the number of times the data group in the shift buffer 502 is used increases by one to become nine times, and the count corresponding to the number of times accumulated and added to the acc2 increases by one to become three.

In this way, according to the size and form of the filter 503, the number of times of use and reuse of data of the data group may be determined. In the above example, since the filter 503 has the form of 3×3 (K=3), the number of same data arrays that the shift buffer 502 transmits to the MACs 504 of the operation unit is defined as three according to a K value, and the MACs 504 perform the convolution operations three times according to the filter 503 and the K value for each data array transmitted from the shift buffer 502. Also, the number of times shifting is performed in the shift buffer 502 is defined as two according to K−1.

That is, in the above example, one data group is shifted and the three-time convolution operation procedures are performed twice more. Accordingly, the use of data of a total of 3×3=9 times (reuse of data eight times) is performed for one data group stored in the shift buffer 502.

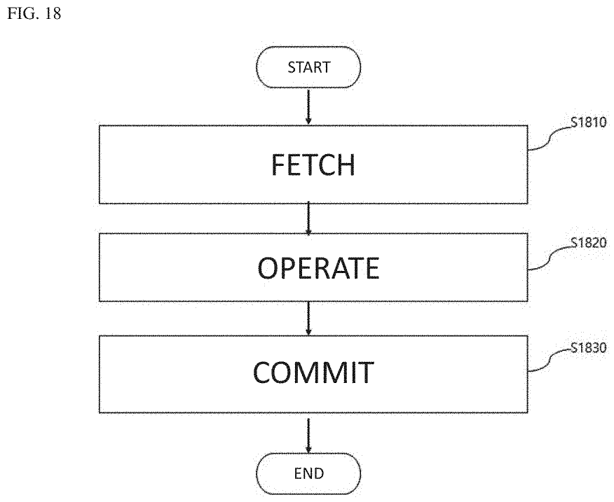

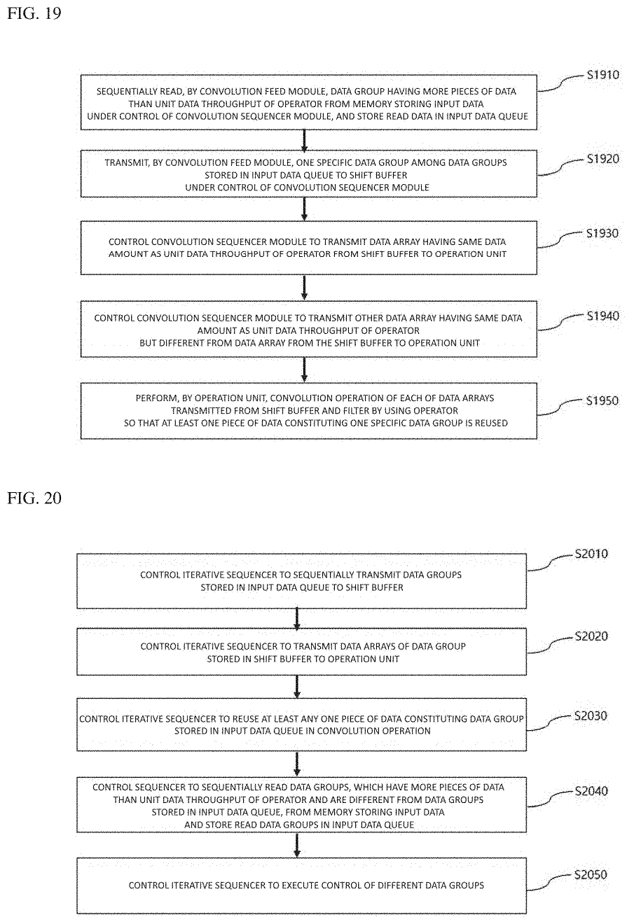

FIG. 18 is a flowchart illustrating procedures of a method of processing a convolution operation according to the embodiment of the present invention, and FIG. 19 is a flowchart for describing detailed procedures of a fetch process and an operation process illustrated in FIG. 18.

A method of processing a convolution operation according to the present embodiment is a method using the device 10 for processing a convolution operation described above with reference to FIGS. 1 to 17, and contents overlapping the above description will be omitted below.

Referring to FIG. 18, the method of processing a convolution operation according to the present embodiment is the method of processing a convolution operation using the device for processing a convolution operation configured to generate the output data configured in the form of width×height×output channel and the output data configured in the form of width×height×output channel by processing the convolution operation of the input data configured in the form of width×height×input channel and the filter formed in the form of K×K×input channel or K×K (K is an integer greater than or equal to one) includes a fetch process (S1810) and an operation process (S1820).

In addition, the method of processing a convolution operation according to the present embodiment may further include a process of storing data used for the convolution operation in the memory before the fetch process (S1810), and a commit process (S1830) performed after the operation process (S1820).

The fetch process (S1810) may be a process of sequentially reading, by the fetch unit of the device for processing a convolution operation, a data group having more pieces of data than the unit data throughput of the operator from the memory storing the input data and providing the data group to the operator so that at least one piece of data among data constituting the data group is reused for the convolution operation. Here, as described above, the fetch unit may include a convolution feed module including the input data queue and the shift buffer, and a convolutional sequencer module including an iterative sequencer and a control sequencer.

The operation process (S1820) may be a process of performing, by the operation unit of the device for processing a convolution operation, the convolution operation of the data constituting the data group according to the unit data throughput and the filter multiple times by using one or more of the operators. Here, the operation unit may include a plurality of operators as described above.

The commit process (S1830) may be a process of transforming, by the commit unit of the device for processing a convolution operation, result data calculated by the operation unit into a preset form and storing the result data in the memory.

Referring to FIG. 19, the fetch process (S1810) may include a process of sequentially reading, by the convolution feed module, the data group having more pieces of data than the unit data throughput of the operator from the memory storing the input data under the control of the convolution sequencer module and storing the read data group in the input data queue (S1910), and a process of transmitting, by the convolution feed module, one specific data group among data groups stored in the input data queue to the shift buffer under the control of the convolution sequencer module (S1920).

Further, the fetch process (S1810) may further include a process (S1930) of controlling, by the convolutional sequencer module, a data array having the same data amount as the unit data throughput of the operator from the shift buffer to the operation unit, and a process (S1940) of controlling, by the convolution sequencer module, another data array, which has the same data amount as the unit data throughput of the operator for reuse of data but is slightly different from the data array due to the data shift to be transmitted from the shift buffer to the operation unit.

Here, the data array and another data array corresponds to a sequential part of data constituting the one specific data group and may be configured to have the same data part and different data parts due to the data shift.

The operation process proceeding following process S1940 of the fetch process (S1810) may be a process (S1950) of performing, by the operation unit, the convolution operation of each of the data arrays transmitted from the shift buffer and the filter by using the operator so that at least one piece of data among the data constituting the one specific data group is reused.

FIG. 20 is a diagram for describing in more detailed procedures performed by a convolution sequencer module of the present invention.

Referring to FIG. 20, the fetch process (S1810) may include a process (S2010) of controlling, by the iterative sequencer, the data groups stored in the input data queue to be sequentially transmitted to the shift buffer, a process (S2020) of controlling, by the iterative sequencer, the data arrays of the data group stored in the shift buffer to be transmitted to the operation unit, and a process (S2030) of controlling, by the iterative sequencer, at least one piece of data among the data constituting the data group stored in the input data queue to be reused in the convolution operation.

In addition, in an embodiment of the present invention, when the control completion notification for the data groups stored in the input data queue is received (or issued) from the iterative sequencer, a process (S2040) of controlling the control sequencer to sequentially read data groups, which have more pieces of data than the unit data throughput of the operator and are different from the data groups stored in the input data queue, from the memory storing the input data and storing the read data groups in the input data queue and a process (S2050) of controlling the iterative sequencer to execute control of the different data groups may be further performed.

In the present embodiment, the amount of data in the data array may be the same as UnitSize(#MAC), which is the unit data throughput of the operator. In addition, the amount of data in the data group may be defined by a formula {floor(K/2)+UnitSize(#MAC)+floor(K/2)} or more obtained by adding floor(K/2), which is a maximum integer value of K/2, to the UnitSize(#MAC), which is the unit data throughput of the operator, twice. That is, the amount of data in the data group may be {floor(K/2)+UnitSize(#MAC)+floor(K/2)} or more depending on the hardware configuration of the fetch unit, the operation unit, and the like. Here, K is a constant determined according to the form K×K of the filter and may be an integer greater than or equal to one. Similarly, another data array may be a data array of an area shifted according to a preset standard from the data array in the data group transmitted from the shift buffer.

In the present embodiment, the number of data arrays controlled to be transmitted from the shift buffer to the operation unit for the one specific data group by the convolution sequencer module may be K. Also, by the operator, the convolution operation of the filter may be performed K times for each data array transmitted from the shift buffer. Accordingly, the number of times data of the one specific data group is used may be K² times.

The above description of the present invention is for illustrative purposes, and those skilled in the art to which the present invention pertains will understand that it is possible to be easily modified to other specific forms without changing the technical spirit or essential features of the present invention. Therefore, it is to be understood that the exemplary embodiments described hereinabove are illustrative rather than being restrictive in all aspects. It is to be understood that the scope of the present invention will be defined by the claims described below and all modifications and alternations derived from the claims and their equivalents are included in the scope of the present invention.

Although the disclosure has been described with respect to only a limited number of embodiments, those skill in the art, having benefit of this disclosure, will appreciate that various other embodiments may be devised without departing from the scope of the present invention. Accordingly, the scope of the invention should be limited only by the attached claims.

1.-20. (canceled)

21. A device for processing convolution operations, comprising:
a processor that:
executes, in a neural network, a convolution operation on input data in a form of width×height×input channel and on a filter in a form of K×K×input channel or K×K to correspond to a form of the input data, K being an integer greater than or equal to one, and
generates output data in a form of width×height×output channel; and
a reader that:
sequentially reads, from a memory storing the input data, a data group having more pieces of data than unit data throughput of an operator, and
provides the data group to the operator to reuse at least one piece of data constituting the data group in the convolution operation, wherein
the processor further executes, by using one or more operators identical to the operator, the convolution operation on the data constituting the data group and on the filter multiple times based on the unit data throughput.

22. The device of claim 21, wherein
the reader comprises:
a convolution feeder; and
a convolution sequencer comprising an input data queue and a shift buffer, and the convolution feeder:
sequentially reads data groups each having more pieces of data than the unit data throughput from the memory under control of the convolution sequencer,
stores the data groups in the input data queue, and
transmits one of the data groups stored in the input data queue to the shift buffer.

23. The device of claim 22, wherein
the convolution sequencer:
transmits a data array having a data amount that is the same as the unit data throughput from the shift buffer to the processor, and
transmits another data array having a data amount that is the same as the unit data throughput but different from the data array from the shift buffer to the processor, and
the data array and the other data array correspond to a sequential part of the data constituting the one of the data groups and have same data part and different data parts as and from each other.

24. The device of claim 23, wherein the processor executes the convolution operation on the data array transmitted from the shift buffer and on the filter by using the operator to reuse at least one piece of data constituting the one of the data groups.

25. The device of claim 23, wherein
the convolution sequencer:
sequentially transmits data groups stored in the input data queue to the shift buffer,
transmits the data array of each of the data groups stored in the shift buffer to the processor to reuse at least any one piece of the data constituting the data groups stored in the input data queue in the convolution operation,
sequentially reads, from the memory, data groups that have more pieces of data than the unit data throughput and are different from the data groups stored in the input data queue,
stores the data groups in the input data queue when a control completion notification is issued for the data groups stored in the input data queue, and
controls the different data groups.

26. The device of claim 23, wherein
an amount of data in the data array is the same as UnitSize(#MAC) that is the unit data throughput, and
an amount of data in each of the data groups is defined by a formula {floor(K/2)+UnitSize(#MAC)+floor(K/2)} or more obtained by adding floor(K/2) that is a maximum integer value of K/2, to the UnitSize(#MAC) that is the unit data throughput, twice, where K is a constant determined based on the form of the filter K×K×input channel or K×K and is an integer greater than or equal to one.

27. The device of claim 23, wherein the other data array is of an area shifted based on a preset standard from the data array in the data group of the shift buffer.

28. The device of claim 26, wherein
a number of data arrays transmitted from the shift buffer to the processor for the one of the data groups by the convolution sequencer is K, and
as the convolution operation on the filter is executed K times for the data array transmitted from the shift buffer by the operator, a number of times of using data of the one of the data groups is K² times.

29. The device of claim 21, further comprising:
a commit unit that transforms result data calculated by the processor into a preset form and stores the data in the memory.

30. The device of claim 22, wherein
the reader further comprises:
a fetch buffer from which data stored in the memory is taken,
a fetch sequencer that takes data from the memory to the fetch buffer, and
a fetch network that transmits the taken data to the convolution feeder.

31. A method of processing convolution operations, the method comprising:
executing, in a neural network, a convolution operation on input data in a form of width×height×input channel and on a filter in a form of K×K×input channel or K×K to correspond to a form of the input data, K being an integer greater than or equal to one, and generating output data in a form of width×height×output channel;
sequentially reading a data group having more pieces of data than unit data throughput of an operator from a memory storing the input data, and providing the data group to the operator to reuse at least one piece of data constituting the data group in the convolution operation; and
further executing the convolution operation on the data constituting the data group and on the filter multiple times using one or more of operators identical to the operator based on the unit data throughput.

32. The method of claim 31, further comprising:
sequentially reading data groups each having more pieces of data than the unit data throughput from the memory,
storing the data groups in an input data queue; and
transmitting one of the data groups stored in the input data queue to a shift buffer.

33. The method of claim 32, further comprising:
transmitting a data array having a data amount that is same as the unit data throughput from the shift buffer to a processor; and
transmitting another data array having a data amount that is same as the unit data throughput but different from the data array from the shift buffer to the processor, wherein
the data array and the other data array correspond to a sequential part of the data constituting the one of the data groups and have same data part and different data parts as and from each other.

34. The method of claim 33, further comprising:
executing the convolution operation on the data array transmitted from the shift buffer and on the filter by using the operator to reuse at least one piece of data constituting the one of the data groups.

35. The method of claim 32, further comprising:
sequentially transmitting data groups stored in the input data queue to the shift buffer;
transmitting the data array of each of the data groups stored in the shift buffer to a processor; and
reusing at least any one piece of the data constituting the data groups stored in the input data queue in the convolution operation.

36. The method of claim 35, further comprising:
when a control completion notification is issued for the data groups stored in the input data queue, sequentially reading data groups that have more pieces of data than the unit data throughput and are different from the data groups stored in the input data queue, from the memory, and storing the data groups in the input data queue; and
controlling the different data groups.

37. The method of claim 33, wherein
an amount of data in the data array is the same as UnitSize(#MAC) that is the unit data throughput, and
an amount of data in each of the data groups is defined by a formula {floor(K/2)+UnitSize(#MAC)+floor(K/2)} or more obtained by adding floor(K/2) that is a maximum integer value of K/2, to the UnitSize(#MAC) that is the unit data throughput, twice, where K is a constant determined based on the form of the filter K×K×input channel or K×K and is an integer greater than or equal to one.

38. The method of claim 33, wherein the other data array is of an area shifted based on a preset standard from the data array in the data group of the shift buffer.

39. The method of claim 37, wherein
a number of data arrays transmitted from the shift buffer to the processor for the one of the data groups is K, and
as the convolution operation on the filter is executed K times for the data array transmitted from the shift buffer by the operator, a number of times of using data of the one of the data groups is K² times.

40. The method of claim 31, further comprising
transforming calculated result data into a preset form and storing the data in the memory.
